(19) United States
(12) Patent Application Publication
(10) Pub. No.: US 2026/0278307 A1
(43) Pub. Date: Sep. 17, 2026

(54) TEMPLATE TRANSLATION USING INTER-LANGUAGE FONT SIMILARITY

(71) Applicant: ADOBE INC., SAN JOSE, CA (US)

(72) Inventors: Amit Vikram Singh, Varanasi (IN); Ashutosh Sharma, Noida (IN); Vineet Batra, Delhi (IN)

(21) Appl. No.: 19/076,455

(22) Filed: Mar. 11, 2025

(51) Int. Cl. G06F 40/58; G06F 40/109; G06V 20/62

(52) U.S. Cl. CPC G06F 40/58; G06F 40/109; G06V 20/62

(57) ABSTRACT

A method, apparatus, non-transitory computer readable medium, and system for obtaining a first image depicting a first font in a first language. An image encoder model is configured to encode the first image to obtain a first image embedding representing the first font. The image encoder model computes a similarity score between the first font and a second font in a second language based on the first image embedding and subsequently selects the second font as a similar font to the first font in the second language based on the similarity score. Then, a document with the second font in the second language is generated based on the selection of the second font as the similar font to the first font

### BACKGROUND

The following generally relates to machine learning, and more specifically to document translation using a machine learning model. Machine learning algorithms build a model based on sample data, known as training data, to make a prediction or a decision in response to an input without being explicitly programmed to do so. One area of application for machine learning is document translation.

For example, a machine learning model can be trained to predict features for text in response to an input prompt, and then translate the text based on the predicted features. In some cases, the machine learning model can be used to translate text into a structured format or another language while preserving the meaning and visual appeal. Such generative machine learning models provide for a user to translate a text and generate translated text with desired features and therefore makes text translation easier for a layperson. In some examples, document processing methods are used to identify features of text in a desired language, for example, identify a font associated with a language, in response to a user query.

### SUMMARY

The present disclosure describes systems and methods for image processing, more specifically to document translation. Embodiments of the present disclosure include a document processing apparatus configured to generate a template based on an input query (e.g., a user-provided query). In some cases, the document processing apparatus takes as input a template in a first language and efficiently and accurately translates the template into a second language. In some examples, the generated template is semantically similar to an input template. According to an embodiment, a residual network of the document processing apparatus identifies a font in the second language that matches the font of the first language. In some cases, the identified font of the second language is incorporated into the generated template.

A method, apparatus, and non-transitory computer readable medium for document processing are described. One or more aspects of the method, apparatus, and non-transitory computer readable medium include obtaining a first image depicting a first font in a first language; encoding, using an image encoder model, the first image to obtain a first image embedding representing the first font; computing a similarity score between the first font and a second font in a second language based on the first image embedding; selecting the second font as a similar font to the first font in the second language based on the similarity score; and generating a document with the second font in the second language based on the selection of the second font as the similar font to the first font.

A method, apparatus, and non-transitory computer readable medium for document processing are described. One or more aspects of the method, apparatus, and non-transitory computer readable medium include encoding, using an image encoder model, a first image to obtain a first image embedding representing a first font; computing a similarity score between the first font and a second font in a second language based on the first image embedding; and generating a document with the second font in the second language based on the similarity score.

An apparatus and system for document processing are described. One or more aspects of the apparatus and system include a memory component; a processing device coupled to the memory component, the processing device configured to perform operations comprising: obtaining a first image depicting a first font in a first language; encoding, using an image encoder model, the first image to obtain a first image embedding representing the first font; computing a similarity score between the first font and a second font in a second language based on the first image embedding; and selecting the second font as a similar font to the first font in the second language based on the similarity score.

### BRIEF DESCRIPTION OF THE DRAWINGS

FIG. 1 shows an example of a document processing system according to aspects of the present disclosure.

FIG. 2 shows an example of a method for translating a template according to aspects of the present disclosure.

FIG. 3 shows an example of a document translation process according to aspects of the present disclosure.

FIGS. 4 through 5 show examples of methods for document processing according to aspects of the present disclosure.

FIG. 6 shows an example of an algorithm for identifying a visually similar font according to aspects of the present disclosure.

FIG. 7 shows an example of a data generation framework according to aspects of the present disclosure.

FIG. 8 shows an example of a method of training a machine learning model according to aspects of the present disclosure.

FIG. 9 shows an example of a computing device according to aspects of the present disclosure.

FIG. 10 shows an example of a document processing apparatus according to aspects of the present disclosure.

FIG. 11 shows an example of an image encoder model according to aspects of the present disclosure.

### DETAILED DESCRIPTION

The present disclosure describes systems and methods for document processing, more specifically, to document translation. Embodiments of the present disclosure include a document processing apparatus configured to generate a template based on an input query (e.g., a user-provided query). In some cases, the document processing apparatus takes as input a template in a first language and efficiently and accurately generates the template in a second language. In some examples, the generated template is semantically similar to an input template. According to an embodiment, a residual network of the document processing apparatus identifies a font in the second language that is visually similar to the font in the first language. In some cases, the identified font is incorporated into the template generated in the second language.

Conventional template translation systems use a specific font or style irrespective of the style of the input template or only differentiate between high level styles such as “serif” and “sans-serif”. For example, in case of input templates that include text in different fonts such as “Ariel”, “Verdana” and “Segoe Print” in the English language, existing document translation systems may consistently use the “Source Han Sans” font in the Chinese language for the generated template. As a result, the generated templates lack visual appeal and appear monotonous. Additionally, the generated templates are unable to capture the aesthetics and stylistic features of the input template resulting in low user engagement and less attractive translated template.

Other systems select a font based on the semantic content of the text. In some cases, a model may be trained only on a single font which limits the accuracy of the model in generating features in the template that are used for inter-language similarity. Therefore, there is a need in the art for a document processing system that can perform document translation to a desired language while incorporating the font suggestions, resulting in a visually attractive and engaging translated template.

Embodiments of the present disclosure include a document processing apparatus configured to translate a template to a second language. In some cases, the second language is selected from a plurality of languages. In some cases, the document processing apparatus is jointly trained based on a font classification model for the plurality of languages. In some cases, the template is translated and a font that is visually similar to a first font of an input template is incorporated into the translated template. For example, the visual similarity of the font is identified by computing an inter-language font similarity between the first font of the input template and a font of the second language.

The present disclosure describes systems and methods for document processing, more specifically to document translation. In some cases, the document processing apparatus takes as input a template in a first language and efficiently translates the template to a second language. According to an exemplary embodiment, the document processing apparatus of the present disclosure comprises a machine learning model (e.g., an image encoder model) for performing a joint classification on a plurality of fonts of the second language.

According to an embodiment, the document processing apparatus takes a font of the first language and the second language as input and efficiently and accurately predicts a visually similar font in the second language. In some cases, the document processing apparatus performs the prediction using a feature obtained from the machine learning model. For example, the machine learning model is a trained deep learning model. In some examples, the machine learning model comprises a convolutional neural network architecture. In some examples, the machine learning model comprises a ResNet architecture. In some cases, the document processing apparatus performs the prediction based on computing an inter-language similarity score between a font of the first language and the font of the second language.

An embodiment of the present disclosure is configured to perform a test time augmentation process. In some cases, the inter-language similarity score is computed once followed by storing a mapping of the font of the first language with the font of the second language. For example, the document processing apparatus of the present disclosure generates a synthetic image corresponding to a text in the first language. Additionally, for example, the document processing apparatus generates a synthetic image corresponding to each font in the second language. Accordingly, by performing test time augmentation that generates a synthetic image corresponding to each font, embodiments of the present disclosure are able to significantly enhance a font prediction by the trained deep learning model.

According to an embodiment, the document processing apparatus is configured to train a classification model. In some cases, the trained classification model (e.g., comprising a ResNet architecture) takes an image of a font of the first language as input and accurately identifies the font of the first language in an input template. For example, the classification model is jointly trained on a plurality of languages. In some examples, the classification model is trained on languages such as, but not limited to, English, Japanese, Korean, Chinese Simplified, and Chinese Traditional.

According to an embodiment, the document processing apparatus of the present disclosure is configured to take the identified font of the first language and a font (e.g., each font of the plurality of fonts) of the second language as input. In some cases, the document processing apparatus extracts a first embedding for the identified font. Additionally, in some cases, the document processing apparatus extracts a second embedding (e.g., plurality of second embeddings) associated with the font (e.g., each font of the plurality of fonts) of the second language. The document processing apparatus identifies a target font of the second language based on computing a cosine distance between the first embedding and the second embedding (e.g., plurality of second embeddings).

As described herein, a first image refers to a template that is used for making a flyer, poster, etc. In some cases, the templates are in a first language and hence not suitable for users who design a template in another language (e.g., a second language). For example, the templates are in English language and a user wants a ready-made template in another language (e.g., Japanese, Korean, Chinese, etc.).

In some cases, the translated template is generated based on incorporating the identified font in the second language (e.g., Japanese, Chinese, Korean, etc.) that includes the same characteristics as the font in the first language (e.g., English) and evokes the same emotions as the font in the first language. For example, a similarity score is computed using a cross-language font similarity algorithm to identify the font of the second language. In some examples, an auto-translate feature identifies the font in the second language that has the same characteristics as the font in the first language.

Accordingly, embodiments of the disclosure improve on conventional machine translation systems by enabling more accurate translation of the source document text, including more accurate font selection. Specifically, embodiments select a font that conveys a similar appearance to the source font. By identifying a font in the second language that is visually similar to the first font in the first language, embodiments of the present disclosure are able to provide a translated template that is visually appealing and attractive. Additionally, by computing the inter-language similarity while utilizing the embedding information for the template, embodiments are able to perform test time augmentation which further enhances the accuracy of identifying the appropriate font in the second language.

As described herein, “language” refers to a system of symbols, characters, or words used to convey information, typically in the form of a natural language. For example, languages such as English, Chinese, Japanese, etc. can be characterized by the associated vocabulary, grammar, and syntax rules, which define how symbols and words are organized to communicate meaning or perform computational tasks. In some cases, a “font” is a specific graphical representation of characters, symbols, or glyphs used in textual content. For example, a font is typically defined by, but not limited thereto, the typeface (e.g., Times New Roman or Arial), size, weight (e.g., bold or light), style (e.g., italic or regular), and spacing.

Additionally, a “similar font” refers to a typeface or graphical representation of text that closely resembles another font in one or more attributes, such as, but not limited to, shape, size, or style of characters. Similarity between fonts (e.g., fonts associated with a language, or fonts associated with different languages) may be determined by visual comparison or computational analysis of font metrics (e.g., curvature, stroke width, or spacing).

As used herein, an “image embedding” refers to the process of encoding an image into a fixed-dimensional vector or numerical representation. In some cases, the representation captures the visual features of the image, such as color, shape, and texture, in a format suitable for machine learning or computational analysis. Additionally, a “similarity score” refers to a numerical value that quantifies the degree of similarity between data elements, such as text, images, or embeddings. In some cases, the score is computed using algorithms or mathematical functions, such as, but not limited to, cosine similarity. For instance, a high similarity scores indicates high resemblance between the compared elements.

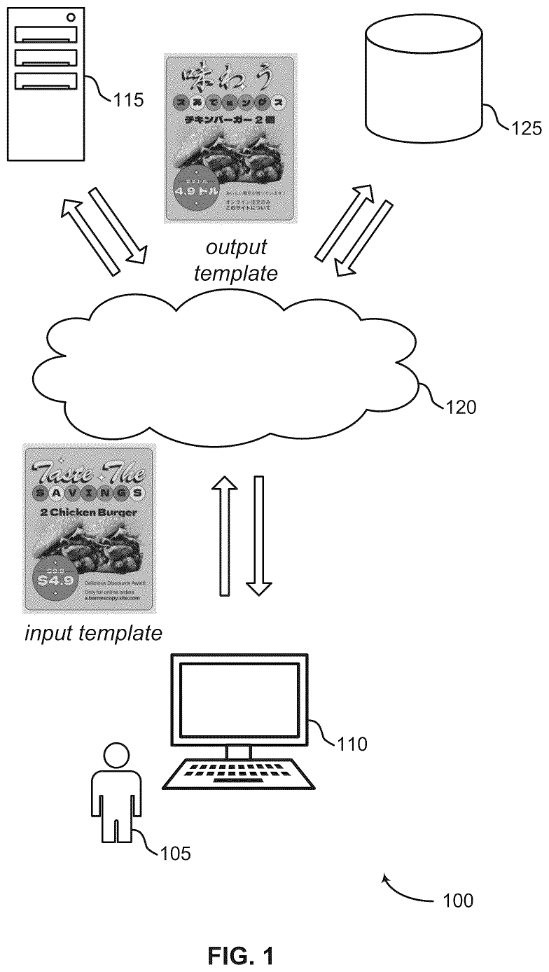

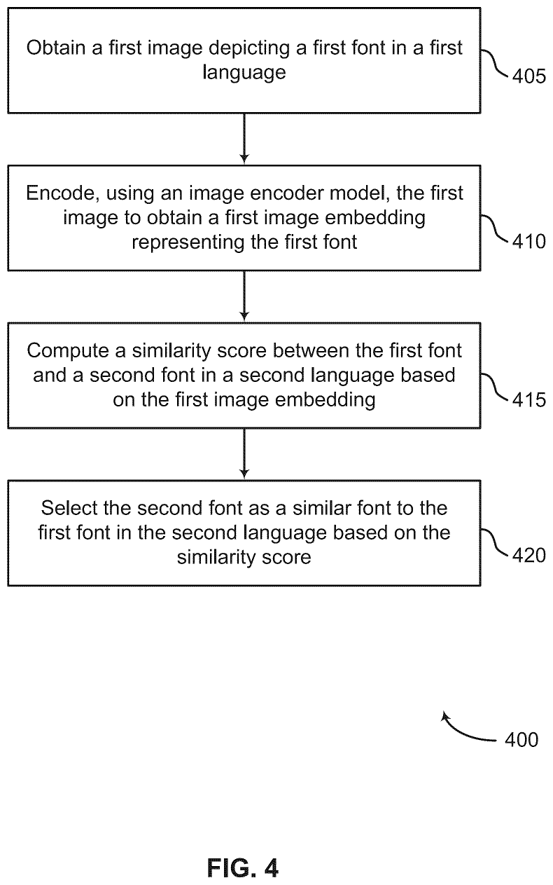

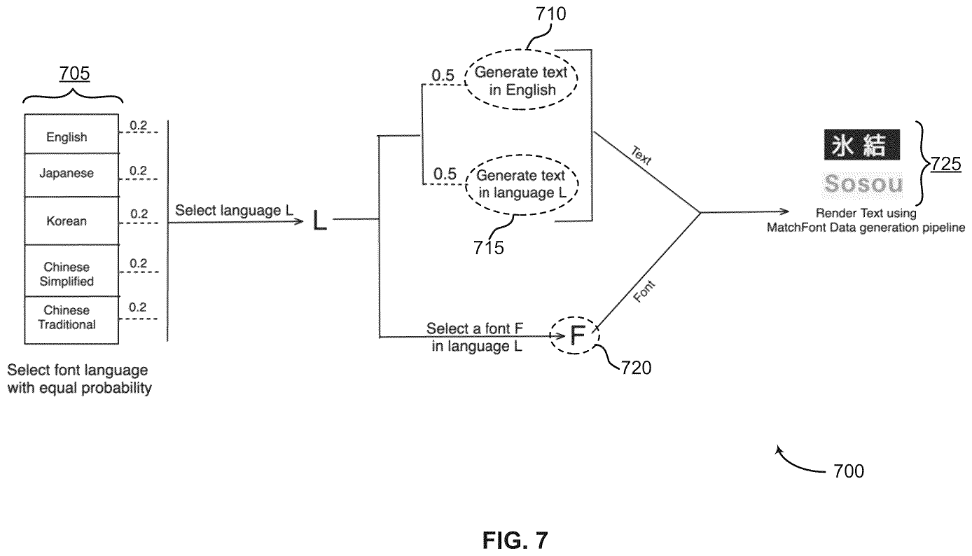

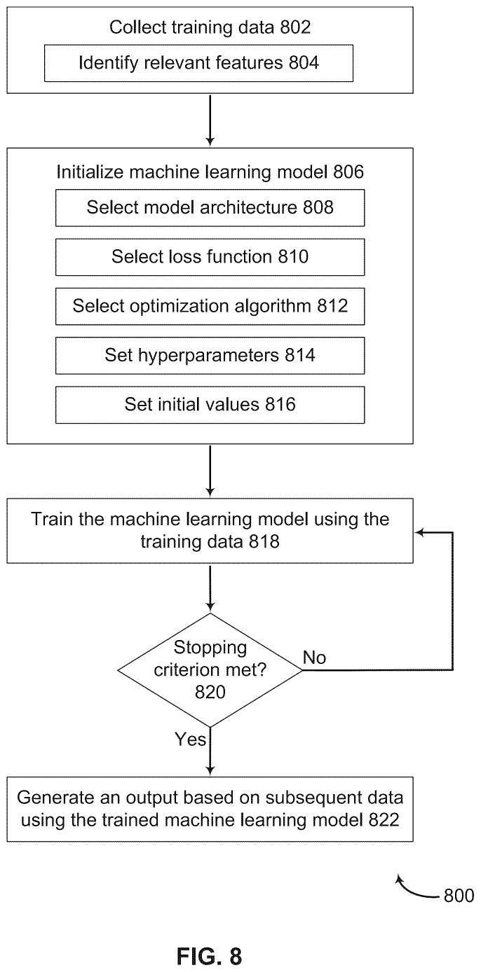

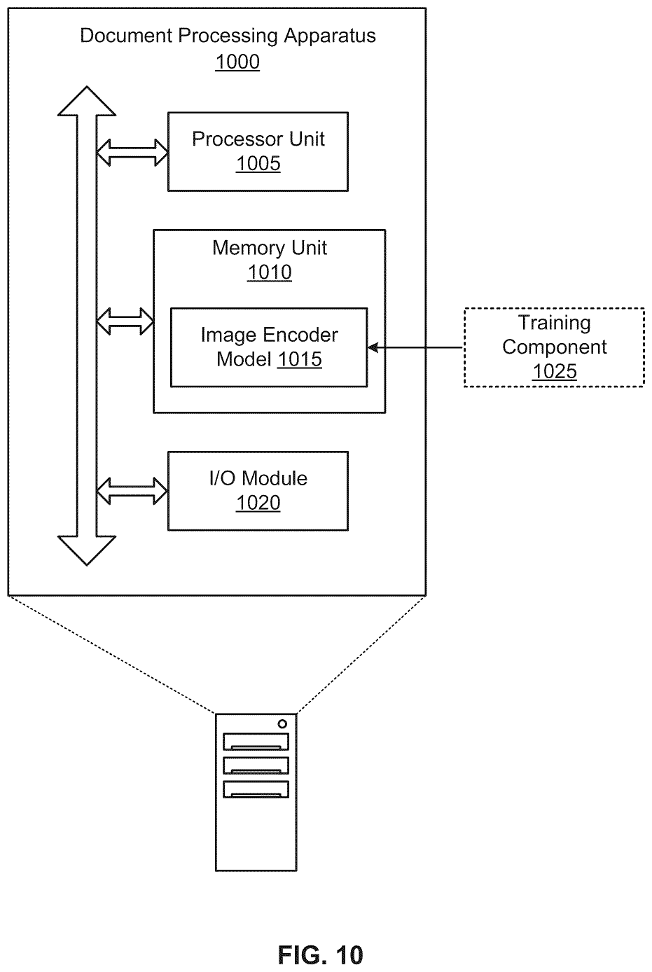

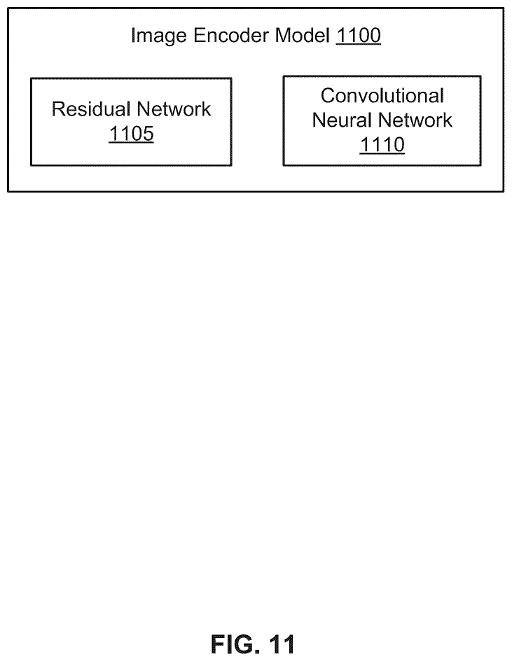

Embodiments of the present disclosure can be implemented in a document translation system. For example, the document translation system based on the present disclosure takes an input template and accurately translates the template to another language while aligning with the font style of the input template. Example applications regarding document translation are provided with reference to FIG. 1-3. Details regarding the architecture of the document translation system are provided with reference to FIGS. 10-11. Details regarding an operation of the document translation system are provided with reference to FIGS. 4-6. Examples of a process for training the document translation system are provided with reference to FIG. 7-8.

### Document Translation System

A system and an apparatus for document translation are described with reference to FIGS. 1-3. FIG. 1 shows an example of a document processing system 100 according to aspects of the present disclosure. In one aspect, document processing system 100 includes user 105, user device 110, document processing apparatus 115, cloud 120, and database 125.

In the example of FIG. 1, user 105 provides a template depicting text in a first language (e.g., English) to document processing apparatus 115 via a user interface provided on user device 110 by document processing apparatus 115. As used herein, the input template indicates a template a user wants to translate. According to some aspects, document processing apparatus 115 obtains an input template, i.e., comprising text in a first language (e.g., English). However, embodiments are not limited thereto, and the first language may be any language other than English.

In some cases, the document processing apparatus 115 implements an image encoder model (such the image encoder model described with reference to FIGS. 4-6) to generate a translated template. In some cases, as shown in FIG. 1, the user provides an input template to the document processing apparatus 115, aspects of which the user wants to obtain in the translated template. In some examples, the document processing apparatus accurately generates a translated template that includes text in a font that is visually similar to the font in the first language. For example, as shown in FIG. 1, the document processing apparatus 115 provides an output (i.e., a translated template) in a font that has similar attributes as the font in the input template.

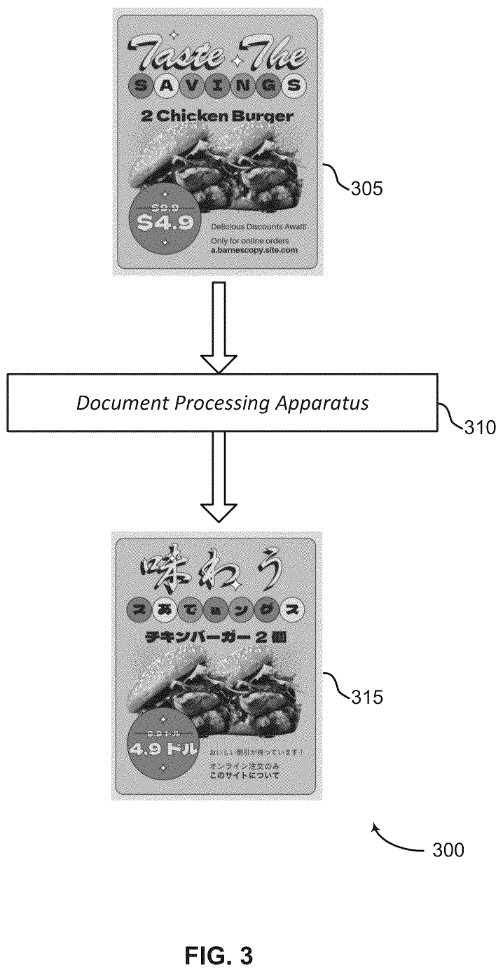

Referring to the example of FIG. 1, the document processing apparatus 115 provides the translated template (i.e., output template) to user 105 via the user interface provided on user device 110. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by document processing apparatus 115. In some aspects, the user interface provides for information (such as templates, images, documents, prompt, etc.) to be communicated between user 105 and document processing apparatus 115. Document processing apparatus 115 is an example of, or includes aspects of, the corresponding element described with reference to at least FIGS. 3 and 10.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

According to some aspects, document processing apparatus 115 includes a computer-implemented network. In some embodiments, the computer-implemented network includes a machine learning model (such as the machine learning model described with reference to FIGS. 4-5 and 10-11). In some embodiments, document processing apparatus 115 also includes one or more processors, a memory subsystem, a communication interface, an I/O interface, one or more user interface components, and a bus as described with reference to FIG. 10. Additionally, in some embodiments, document processing apparatus 115 communicates with user device 110 and database 125 via cloud 120.

In some cases, document processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, document processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to document processing apparatus 115 and communicates with document processing apparatus 115 via cloud 120. According to some aspects, database 125 is included in document processing apparatus 115.

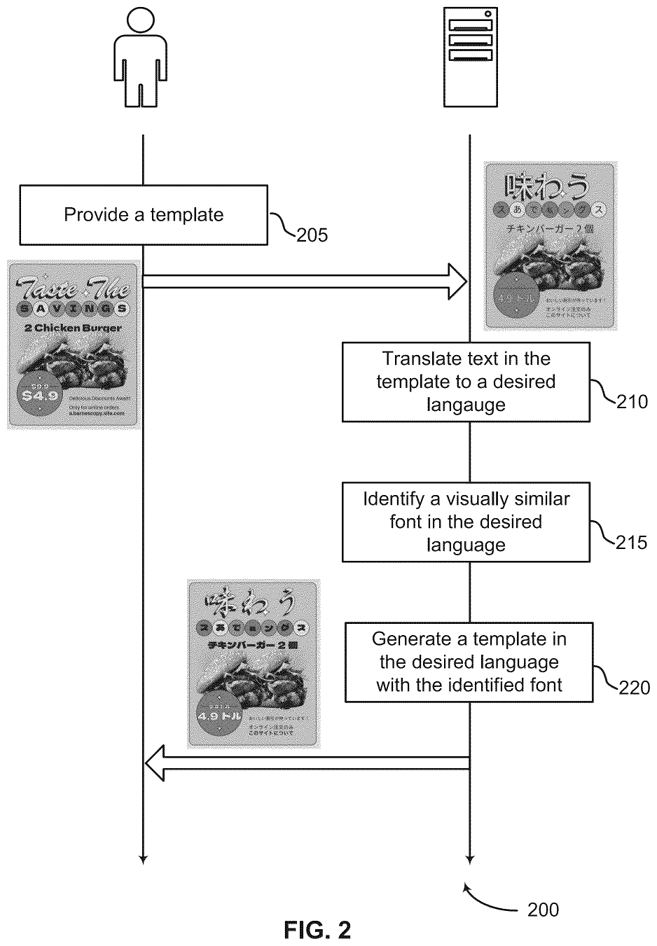

FIG. 2 shows an example of a method 200 for translating a template according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

According to an embodiment of the present disclosure, a document processing apparatus (such as the document processing apparatus described with reference to FIGS. 3 and 10) provides a machine learning model that accurately translates an input template (e.g., a user-provided template). In some cases, the document processing apparatus is configured to generate a translated template, wherein the translated template comprises text in a font that is visually similar to the font in the text of the input template.

At operation 205, the system provides a template. In some cases, the operations of this step refer to, or may be performed by, a document processing apparatus as described with reference to FIGS. 1 and 3.

In some examples, the user provides a template to the document processing apparatus (such as the document processing apparatus described with reference to FIG. 1). As shown in FIG. 2, the template comprises text in a first language (e.g., English language) that the user wants to translate to another language. For example, the user wants the translated template to depict text in a font that is visually similar and hence has the same appeal as the input template. In some cases, the user provides the input template to the document processing apparatus via a user interface (such as a graphical user interface) provided on a user device by the document processing apparatus.

At operation 210, the system translates the text of the template to the desired language. In some cases, the operations of this step refer to, or may be performed by, a document processing apparatus as described with reference to at least FIGS. 1 and 10.

The present disclosure describes systems and methods for document translation. An embodiment of the present disclosure is configured to receive an input template comprising text and performs a translation of the text in the input template to generate a translated template. As shown in FIG. 2, operation 210 is configured to translate the input template in English to another language (e.g., Japanese, Chinese, Korean, etc.) with a script different from the script of the input template (e.g., English). In some cases, the document processing apparatus generates a translated template that depicts the translated text in a standard font of the other language (e.g., Japanese, Chinese, Korean, etc.).

Embodiments of the present disclosure are configured to perform inter-language font similarity. In some cases, template translation is challenging since the user (e.g., designer) manually selects a specific font to enhance the visual appeal of the template. In some cases, generation of the translated template comprises translating the text in the input template from the first language to the second language while ensuring that the font in the second language maintains the visual appeal of the translated template.

Accordingly, at operation 215, the system identifies a font in the desired language. In some cases, the operations of this step refer to, or may be performed by, a document processing apparatus as described with reference to at least FIGS. 1 and 10.

In some cases, the document processing apparatus is configured to modify the translated template based on incorporating a font in a second language (e.g., Japanese, Chinese, Korean, etc.) that includes the same characteristics as the font in the first language and evokes the same emotions as the font in the first language. For example, the document processing apparatus utilizes a cross-language font similarity algorithm to identify the font of the second language. In some examples, the document processing apparatus includes an auto-translate feature that identifies the font in the second language that has the same characteristics as the font in the first language. Further details regarding the identification of the font are provided with reference to at least FIGS. 4-6.

At operation 220, the system generates a template in the desired language with the identified font. In some cases, the operations of this step refer to, or may be performed by, a document processing apparatus as described with reference to at least FIGS. 1 and 10.

Embodiments of the present disclosure are configured to perform a document translation. In some cases, the translated template is used for making a flyer, poster, etc. in a language desired by the user. For example, the document processing apparatus is able to accurately generate a translated template by implementing a font of the desired (second) language with the font attributes of the font of the first language. For example, in some cases, the document processing apparatus displays the translated template to the user via the user interface (such as the user interface described with reference to FIG. 1).

In some examples, a ready-made translated template is desired by the user. In some examples, the input template is in a first (e.g., English) language and hence not suitable for users who design a template in another language (e.g., Japanese, Korean, Chinese, etc.). In some cases, translation of the template from a first language (such as English) to a second language (such as Japanese) makes the template accessible to a high number of users.

FIG. 3 shows an example of a document translation process 300 according to aspects of the present disclosure. In one aspect, document translation process 300 includes input template 305, document processing apparatus 310, and output template 315.

Referring to FIG. 3, input template 305 comprises text that a user wants to translate. In some cases, input template 305 is in a first language (e.g., English language) and is not suitable for users who design a template in another language that comprises a different script (e.g., Japanese, Korean, Chinese, etc.).

As used herein, a script refers to a system of writing used to visually represent the sounds or words of a language. The language script comprises a set of characters, symbols, or letters used to construct written text. For example, languages such as English and Dutch share the Latin script, which includes the letters A to Z, though the languages differ in grammar, vocabulary, and phonetics. In some examples, languages such as Korean use a different script, such as Hangul, which is a distinct set of symbols and writing rules. Similarly, languages such as Japanese, Chinese, Hindi, etc. each use different language scripts.

The document processing apparatus of the present disclosure receives an input template from a user. In some cases, document processing apparatus 310 is configured to perform a translation of the input template 305 while maintaining the aesthetic appeal of the translated template (such as translated template 315). For example, input template 305 depicts a flyer with text in English. The document processing apparatus 310 modifies input template 305 to generate translated template 315 in a second language (e.g., Korean).

According to an example, document processing apparatus 310 enables a user to provide an input prompt (e.g., a text prompt). In some cases, the user provides the input prompt in a first language (e.g., convert the template to Korean) and the document processing apparatus 310 is configured to generate translated template 315 based on incorporating a font in a second language (e.g., Japanese, Chinese, Korean, etc.) that includes the same characteristics as the font in the first language and evokes the same emotions as the font in the first language.

For example, document processing apparatus 310 utilizes a cross-language font similarity algorithm to identify the font of the second language (e.g., Japanese, Chinese, Korean, etc.). As used herein, the first language and the second language are not limited to the examples mentioned, embodiments can be applied to any set of languages the user wants to perform a translation for. In some examples, the document processing apparatus includes an auto-translate feature that identifies the font in the second language that has the same visual characteristics as the font in the first language. Document processing apparatus 310 is an example of, or includes aspects of, the corresponding element described with reference to FIG. 1.

In some cases, document processing apparatus 310 comprises a machine learning model trained on a classification task. In some cases, the machine learning model is a deep learning model configured to perform a joint classification of the fonts in the second language (e.g., a plurality of second languages such as, but not limited to, Chinese, Japanese, Korean, etc.). For example, the machine learning model takes the font in the first language (e.g., English) and the second language as input, and accurately and efficiently predicts a visually similar font in the second language. Further details regarding this operation are provided with reference to FIGS. 4-6.

In some cases, the translated template 315 is generated based on implementing the visually similar font. By implementing the visually similar font in the translated template, embodiments of the present disclosure are able to maintain the aesthetic appeal of the input template 305 in translated template 315. In some cases, translated template 315 is accessible to a high number of users that are familiar with the second language. Translated template 315 is an example of, or includes aspects of, the corresponding element described with reference to at least FIGS. 1-2.

Accordingly, an apparatus for document processing is described. One or more aspects of the apparatus include a memory component; a processing device coupled to the memory component, the processing device configured to perform operations comprising: obtaining a first image depicting a first font in a first language; encoding, using an image encoder model, the first image to obtain a first image embedding representing the first font; computing a similarity score between the first font and a second font in a second language based on the first image embedding; and selecting the second font as a similar font to the first font in the second language based on the similarity score.

In some aspects, the image encoder model comprises a convolutional neural network. In some aspects, the image encoder model comprises a ResNet architecture. In some aspects, the image encoder model is trained to generate embeddings representing fonts in a plurality of different languages using a training set that includes images depicting fonts in the plurality of different languages.

In some aspects, the processing device is further configured to perform obtain a document template comprising the first font in the first language. Some examples further include generating a document with the second font in the second language based on the document template and the selection of the second font as the similar font to the first font.

### Document Translation Process

The present disclosure describes systems and methods for document translation. For example, a template is used for making a flyer, poster, etc. In some examples, a ready-made template is desired by the user. In some examples, the templates are in English language and hence not suitable for users who design a template in another language (e.g., Japanese, Korean, Chinese, etc.). In some cases, translation of the template from a first language (such as English) to a second language (such as Japanese, Thai, Korean, etc.) makes the template accessible to a high number of users.

In some cases, template translation is challenging since the user (e.g., designer) manually selects a specific font to enhance the visual appeal of the template. In some cases, performing a translation of the template from a first language to a second language comprises first converting the text in the template from the first language to the second language and then selecting an appropriate font in the second language that maintains the visual appeal of the template. Existing systems are able to perform the translation from the first language to the second language but maintenance of the visual appeal of the translated template is extremely challenging. Accordingly, there is a need in the art for providing systems and methods that efficiently translate the template while selecting an appropriate font in the second language to maintain the aesthetic appeal of the template.

The present disclosure describes systems and methods for document translation. In some examples, the document processing apparatus of the present disclosure enables a user to provide an input prompt (e.g., a text prompt) to generate a document. For example, the input prompt is “make a birthday invitation card for my daughter Mia's unicorn-themed 8th birthday”. In some examples, the document processing apparatus uses a template and modifies the template based on the input prompt.

In some cases, the user provides an input template in a first language (e.g., English) and the document processing apparatus is configured to translate the input template to a second language while incorporating a font in the second language (e.g., Japanese, Chinese, Korean, etc.) that includes the same characteristics as the font in the first language and evokes the same emotions as the font in the first language.

Embodiments of the present disclosure are configured to perform a computation of an inter-language font similarity. For example, the document processing apparatus utilizes a cross-language font similarity algorithm to identify the font of the second language. In some examples, the document processing apparatus includes an auto-translate feature that identifies the font in the second language that has the same characteristics as the font in the first language.

FIG. 4 shows an example of a method 400 for document processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 405, the system obtains a first image depicting a first font in a first language. In some cases, the operations of this step refer to, or may be performed by, a document processing apparatus as described with reference to at least FIGS. 1-3 and 10.

For example, as shown with reference to FIGS. 1-3, the document processing apparatus receives a first image, such as the input template described with reference to FIGS. 1-3, that comprises text in a font of the first language. As shown in FIGS. 1-3, the first image depicts text in a font of the English language. In some cases, the document processing apparatus obtains the first image via a user interface, such as the user interface described with reference to FIGS. 1 and 9-10 of the user device.

As used herein, the language refers to a system of symbols, characters, or words used to convey information, typically in the form of a natural language. For example, the first language, such as English, can be characterized by the associated vocabulary, grammar, and syntax rules, which the organization of symbols and words to communicate meaning or perform computational tasks. Additionally, the font refers to a graphical representation of characters, symbols, or glyphs used in textual content. For example, a font is typically defined by, but not limited thereto, the typeface (e.g., Times New Roman or Arial), size, weight (e.g., bold or light), style (e.g., italic or regular), and spacing.

At operation 410, the system encodes, using an image encoder model, the first image to obtain a first image embedding representing the first font. In some cases, the operations of this step refer to, or may be performed by, an image encoder model as described with reference to FIG. 11.

In some cases, the term “encode” refers to the process of converting data or information from a first format or representation to a second format or representation. For example, encoding includes transforming raw data into a structured format, such as converting text into numerical vectors, images into compressed binary formats, or signals into digital representations. In some examples, an image encoder encodes an image by transforming pixel data into a compact feature representation for classification or similarity analysis.

Additionally, the “image embedding” refers to the process of encoding an image into a fixed-dimensional vector or numerical representation. In some cases, the representation captures the visual features of the image, such as color, shape, and texture, in a format suitable for machine learning or computational analysis.

According to an embodiment of the present disclosure, the document processing apparatus comprises an image encoder model with a trained classification model. For example, the trained classification model takes a digital image (e.g., an image of a template in a first language) as input and predicts a font of the first language. For example, the classification model is trained jointly on a plurality of languages to predict a font of the plurality of languages. Further details regarding the classification model are provided with reference to at least FIG. 7.

At operation 415, the system computes a similarity score between the first font and a second font in a second language based on the first image embedding. In some cases, the operations of this step refer to, or may be performed by, an image encoder model as described with reference to FIG. 11.

In some cases, the document processing apparatus is configured to perform a translation of the text in the first image. For example, as described with reference to FIGS. 1-3, the document processing apparatus is configured to perform the translation from the first language (e.g., English) to a second language (e.g., Japanese, Korean, Chinese, etc.). In some cases, the image encoder model of the document processing apparatus is configured to extract a first hidden embedding for the font in the first language and extract a second hidden embedding for each font in the second language.

In some cases, the image encoder model is configured to select the font in the second language that depicts maximum similarity to the font in the first language. For example, the similarity between the font in the first language and the font in the second language is determined based on a cosine distance between the first hidden embedding and the second hidden embedding. In some cases, embodiments of the present disclosure are configured to use an embedding of a penultimate layer of the image encoder model for the determination.

In some examples, the image encoder model is configured to generate 200 font attributes and 200 synthetic images corresponding to each font. As used herein, the font attributes include, but not limited thereto, font size, font color, background color, etc. In some cases, the image encoder model generates an embedding for each image using a deep learning model.

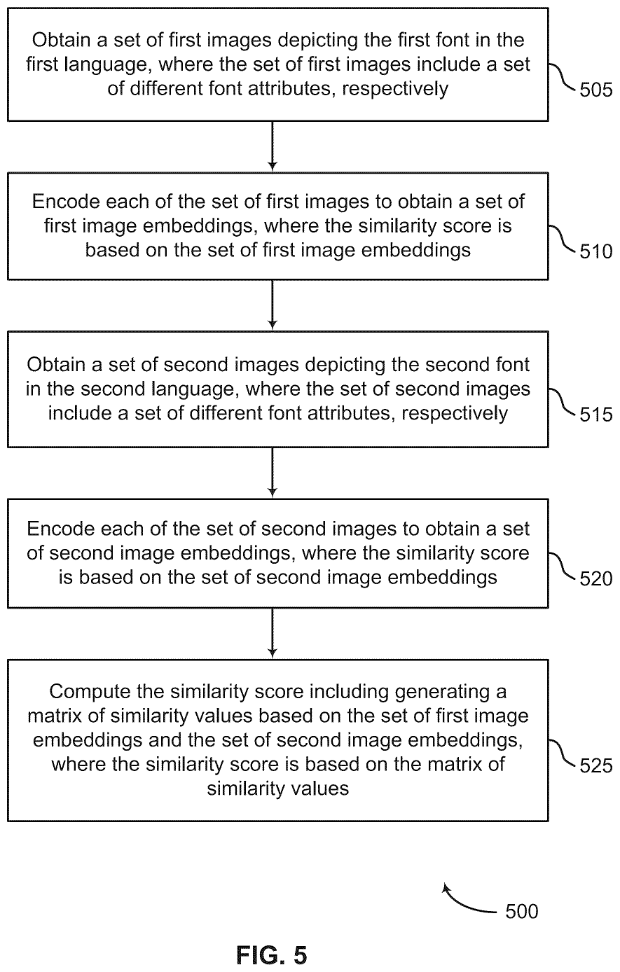

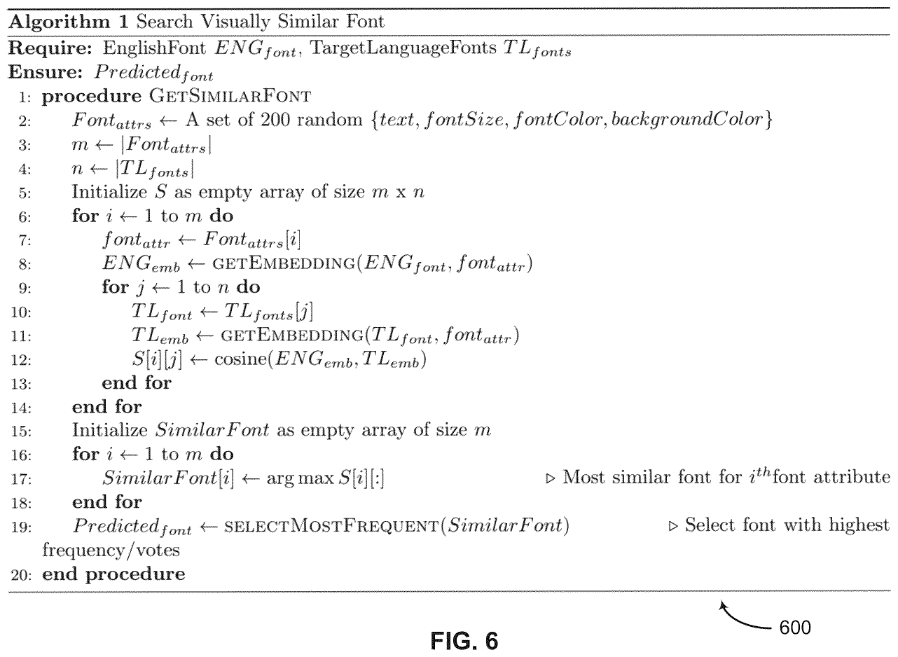

In some cases, the image encoder model is configured to compute a cosine similarity between an image comprising text in a font of the first language and an image comprising text in a font of the second language. In some cases, the font in the first language that has a high cosine similarity to the font in the second language includes the same font attributes. Further details regarding computing the similarity score are provided with reference to at least FIGS. 5-6.

As described herein, the “similarity score” refers to a numerical value that quantifies the degree of similarity between data elements, such as text, images, or embeddings. In some cases, the score is computed using algorithms or mathematical functions, such as, but not limited to, cosine similarity, Euclidean distance, etc. For instance, a high similarity scores indicates high resemblance between the compared elements.

At operation 420, the system selects the second font as a similar font to the first font in the second language based on the similarity score. In some cases, the operations of this step refer to, or may be performed by, an image encoder model as described with reference to FIG. 11.

For example, the term “similar font” refers to a typeface or graphical representation of text that closely resembles another font in one or more attributes, such as, but not limited to, shape, size, or style of characters. In some examples, similarity between fonts may be determined by visual comparison or computational analysis of font metrics, such as curvature, stroke width, or spacing.

According to an embodiment of the present disclosure, the image encoder model is configured to select a font in the second language corresponding to each font attribute. In some cases, the image encoder model selects the font in the second language that has the highest cosine similarity with the font in the first language. For example, the image encoder model generates an array (e.g., SimilarFont array) of size 200 based on the selection corresponding to each font attribute (e.g., for the 200 font attributes). In some examples, the image encoder model selects the font with the highest frequency in the array (e.g., SimilarFont array) as the font in the second language that is visually similar to the font in the first language.

The present disclosure describes systems and method for document translation. Embodiments of the present disclosure include an image encoder model comprising a jointly trained deep learning based font classification model. In some cases, the classification model is trained on a plurality of languages (e.g., English, Japanese, Chinese, Korean, etc.). The image encoder model uses hidden embeddings for each font in the plurality of languages. In some cases, the image encoder model performs a test time augmentation on font attributes for computing an inter-language font similarity. The image encoder model identifies a visually appealing font in the second language (i.e., a plurality of languages), thereby enhancing the overall aesthetic of the translated template.

The document processing apparatus comprises an image encoder model trained on a classification task. In some cases, the image encoder model is a deep learning model configured to perform a joint classification of the fonts in the second language (e.g., a plurality of second languages such as, but not limited to, Chinese, Japanese, Korean, etc.). For example, the image encoder model takes the font in the first language (e.g., English) and the second language as input, and accurately and efficiently predicts a font in the second language. In some examples, the font in the second language is visually similar to the font in the first language. In some examples, the font in the second language is identified using features from the trained deep learning model.

FIG. 5 shows an example of a method 500 for document processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 505, the system obtains a set of first images depicting the first font in the first language, where the set of first images include a set of different font attributes, respectively. In some cases, the operations of this step refer to, or may be performed by, a document processing apparatus as described with reference to at least FIGS. 1-3 and 10.

For example, as shown with reference to FIGS. 1-3, the document processing apparatus receives a set of first images, such as an input template described with reference to FIGS. 1-3, that comprises text in a font of the first language. As shown in FIGS. 1-3, the input images depict text in a font of the English language. Additionally or alternatively, the set of the input images depict text in different fonts of the English language. In some cases, the document processing apparatus obtains the set of first images via a user interface, such as the user interface described with reference to FIGS. 1 and 9-10 of the user device.

At operation 510, the system encodes each of the first images to obtain a set of first image embeddings, where the similarity score is based on the set of first image embeddings. In some cases, the operations of this step refer to, or may be performed by, an image encoder model as described with reference to FIG. 11.

The document processing apparatus of the present disclosure comprises an image encoder model that takes a set of digital images (e.g., a set of images corresponding to a plurality of templates in a first language) as input and generates a set of first image embeddings corresponding to a plurality of fonts of the first language. For example, the image encoder model is trained jointly on a plurality of languages to predict a plurality of fonts associated with each language of the plurality of languages.

In some cases, the document processing apparatus is configured to perform a translation of the text in the first image. For example, as described with reference to FIGS. 1-3, the document processing apparatus is configured to perform the translation from the first language (e.g., English) to a second language (e.g., Japanese, Korean, Chinese, etc.). In some cases, the image encoder model is configured to extract a first hidden embedding for the font in the first language.

At operation 515, the system obtains a set of second images depicting the second font in the second language, where the set of second images include a set of different font attributes, respectively. In some cases, the operations of this step refer to, or may be performed by, a document processing apparatus as described with reference to at least FIGS. 1-3 and 10.

For example, as shown with reference to FIGS. 1-3, the document processing apparatus receives a set of second images, such as a template described with reference to FIGS. 1-3, that comprises text in a font of the second language. In some cases, the text in the second language is generated based on performing a translation from the first language. In some cases, the text in the second language is generated based on a large language model (for example, but not limited to, OpenAI GPT).

As shown with reference to FIGS. 1-3, the images depict text in a font of the Korean language. Additionally or alternatively, the set of the second images depict text in different fonts of the Korean language. In some cases, the document processing apparatus obtains the set of second images via a user interface, such as the user interface described with reference to FIGS. 1 and 9-10 of the user device.

At operation 520, the system encodes each of the set of second images to obtain a set of second image embeddings, where the similarity score is based on the set of second image embeddings. In some cases, the operations of this step refer to, or may be performed by, an image encoder model as described with reference to FIG. 11.

The document processing apparatus of the present disclosure comprises an image encoder model that takes a set of digital images (e.g., a set of images corresponding to a plurality of templates in a second language different from the first language) as input and generates a set of second image embeddings corresponding to a plurality of fonts of the second language. In some cases, the image encoder model is configured to extract a second hidden embedding for each font in the second language. For example, the image encoder model is trained jointly on a plurality of languages to predict a plurality of fonts associated with each language of the plurality of languages.

At operation 525, the system computes the similarity score including generating a matrix of similarity values based on the set of first image embeddings and the set of second image embeddings, where the similarity score is based on the matrix of similarity values. In some cases, the operations of this step refer to, or may be performed by, an image encoder model as described with reference to FIG. 11.

An embodiment of the present disclosure is configured to perform a computation of the font similarity between a font of the first language and a font of a second language. In some examples, the text in the second language is generated based on a large language model (e.g., but not limited to, OpenAI GPT). In some examples, as described with reference to FIGS. 1-3, the document processing apparatus is configured to translate text from the first language (e.g., English) to the second language (e.g., Japanese, Korean, Chinese, etc.). In some cases, an image encoder model of the present disclosure uses an embedding of a penultimate layer of the model for the computation of the font similarity.

In case of the font of the first language and the second language, the image encoder model is configured to generate a synthetic image with text for the font in the first language. Additionally, the image encoder model is configured to generate a synthetic image with text for the font in the second language (e.g., for each font in the second language). In some cases, the image encoder model performs a test time augmentation process for enhancing a prediction of the machine learning model. For example, the image encoder model generates 200 font attributes and 200 synthetic images corresponding to each font.

Subsequently, the image encoder model generates an embedding for each image using the deep learning model. In some cases, the image encoder model is configured to compute a cosine similarity between an image comprising text in a font of the first language and an image comprising text in a font of the second language. In some cases, the font in the first language and the font in the second language include the same font attributes. Further details regarding computation of the font similarity are provided with reference to FIG. 6.

Next, the image encoder model selects the font in the second language for each font attribute. In some cases, the image encoder model selects the font in the second language that has the highest cosine similarity with the font in the first language. For example, the image encoder model generates an array (e.g., SimilarFont array) of size 200 based on each of the 200 font attributes. In some examples, the image encoder model selects the font with the highest frequency in the array (e.g., SimilarFont array) as the font in the second language.

FIG. 6 shows an example of an algorithm 600 for identifying a visually similar font according to aspects of the present disclosure. Algorithm 600 is an example of, or includes aspects of, the similarity score computation in FIGS. 4-5.

Algorithm 600 includes a function for predicting a visually similar font. The function takes an English language font (ENG_{font}) and a target language font (TL_{fonts}) as input and generates a predicted font (Predicted_{font}) as output. At line 1 of the algorithm, procedure GETSIMILARFONT. At line 2, a set of 200 random {text, fontSize, fontColor, backgroundColor} are assigned to Fontₐₜₜᵣₛ (i.e., font attributes). At line 3 of the algorithm, |Fontₐₜₜᵣₛ| is assigned to m. At line 4, |TL_{fonts}| is assigned to n. At line 5 of algorithm 600, S is initialized as an empty array of size m×n.

At line 6, for 1 to m assigned to i, algorithm 600 is executed to run lines 7-12. At line 7, Fontₐₜₜᵣₛ[i] is assigned to fontₐₜₜᵣ. At line 8, GETEMBEDDING (ENG_{font}, fontₐₜₜᵣ) is assigned to ENG_{emb}. At line 9, for 1 to n assigned to j, algorithm 600 is executed to run lines 10-12. At line 10, TL_{fonts}[j] is assigned to TL_{font}. At line 11, GETEMBEDDING (TL_{font}, fontₐₜₜᵣ) is assigned to TL_{emb}. At line 12, cosine (ENG_{emb}, TL_{emb}) is assigned to S[i][j].

At line 15 of algorithm 600, SimilarFont is initialized as an empty array of size m. At line 16, for 1 to m assigned to i, the algorithm is executed to run line 17. At line 17, arg maxS[i][:] is assigned to SimilarFont[i] that depicts the most similar font for the i^{th} font attribute. At line 19, SELECTMOSTFREQUENT (SimilarFont) is assigned to Predicted_{font} which indicates selection of the font with highest frequency/votes.

Accordingly, a method for document processing is described. One or more aspects of the method include obtaining a first image depicting a first font in a first language; encoding, using an image encoder model, the first image to obtain a first image embedding representing the first font; computing a similarity score between the first font and a second font in a second language based on the first image embedding; and selecting the second font as a similar font to the first font in the second language based on the similarity score.

Some examples of the method, apparatus, and non-transitory computer readable medium further include obtaining a second image depicting the second font in the second language. Some examples further include encoding the second image to obtain a second image embedding, wherein the similarity score is based on a similarity between the first image and the second image.

Some examples of the method, apparatus, and non-transitory computer readable medium further include obtaining a plurality of first images depicting the first font in the first language, wherein the plurality of first images comprise a plurality of different font attributes, respectively. Some examples further include encoding each of the plurality of first images to obtain a plurality of first image embeddings, wherein the similarity score is based on the plurality of first image embeddings.

Some examples of the method, apparatus, and non-transitory computer readable medium further include obtaining a plurality of second images depicting the second font in the second language, wherein the plurality of second images comprise a plurality of different font attributes, respectively. Some examples further include encoding each of the plurality of second images to obtain a plurality of second image embeddings, wherein the similarity score is based on the plurality of second image embeddings.

Some examples of the method, apparatus, and non-transitory computer readable medium further include computing the similarity score comprises generating a matrix of similarity values based on the plurality of first image embeddings and the plurality of second image embeddings, wherein the similarity score is based on the matrix of similarity values.

Some examples of the method, apparatus, and non-transitory computer readable medium further include obtaining a document template comprising the first font in the first language. Some examples further include generating a document with the second font in the second language based on the document template and the selection of the second font as the similar font to the first font.

Some examples of the method, apparatus, and non-transitory computer readable medium further include generating a mapping between a plurality of fonts in the first language and a plurality of fonts in the second language based on selection of the second font as the similar font. In some aspects, the first language has a different script than the second language.

In some aspects, the image encoder model is trained to generate embeddings representing fonts in a plurality of different languages using a training set that includes images depicting fonts in the plurality of different languages.

Additionally, a method for document processing is described. One or more aspects of the method include encoding, using an image encoder model, a first image to obtain a first image embedding representing a first font; computing a similarity score between the first font and a second font in a second language based on the first image embedding; and generating a document with the second font in the second language based on the similarity score.

Some examples of the method, apparatus, and non-transitory computer readable medium further include obtaining a second image depicting the second font in the second language and encoding the second image to obtain a second image embedding, wherein the similarity score is based on a similarity between the first image and the second image.

Some examples of the method, apparatus, and non-transitory computer readable medium further include obtaining a plurality of first images depicting the first font in the first language, wherein the plurality of first images comprise a plurality of different font attributes, respectively and encoding each of the plurality of first images to obtain a plurality of first image embeddings, wherein the similarity score is based on the plurality of first image embeddings.

Some examples of the method, apparatus, and non-transitory computer readable medium further include obtaining a plurality of second images depicting the second font in the second language, wherein the plurality of second images comprise a plurality of different font attributes, respectively and encoding each of the plurality of second images to obtain a plurality of second image embeddings, wherein the similarity score is based on the plurality of second image embeddings.

Some examples of the method, apparatus, and non-transitory computer readable medium further include obtaining a document template comprising the first font in the first language, wherein the document is generated based on the document template. Some examples of the method, apparatus, and non-transitory computer readable medium further include the image encoder model trained to generate embeddings representing fonts in a plurality of different languages using a training set that includes images depicting fonts in the plurality of different languages.

### Training

The present disclosure describes systems and methods for translation of an input template. Embodiments of the present disclosure include a document processing apparatus configured to translate the input template from a first language based on identifying a font in a second language. In some cases, the document processing apparatus identifies the font in the second language that visually resembles the font in the first language.

The document processing apparatus comprises a machine learning model trained on a classification task. In some cases, the machine learning model is a deep learning model configured to perform a joint classification of the fonts in the second language (e.g., a plurality of second languages such as, but not limited to, Chinese, Japanese, Korean, etc.). For example, the machine learning model takes the font in the first language (e.g., English) and the second language as input, and accurately and efficiently predicts a font in the second language. In some examples, the font in the second language is visually similar to the font in the first language. In some examples, the font in the second language is identified using features from the trained deep learning model.

In some cases, an inter-language similarity is computed once. In some cases, a mapping of the font in the first language and the font in the second language is obtained based on the inter-language similarity and stored. Accordingly, embodiments of the present disclosure are able to perform test time augmentation for enhancing the accuracy of the document translation.

Embodiments of the present disclosure are configured to perform a document translation. In some cases, the document processing apparatus of the present disclosure comprises a machine learning model that is configured to train a classification model. In some cases, the trained classification model takes a digital image (e.g., an image of a template in a first language) as input and predicts a font of the first language. For example, the classification model is trained jointly on a plurality of second languages.

FIG. 7 shows an example of a data generation framework 700 according to aspects of the present disclosure. In one aspect, data generation framework 700 includes plurality of languages 705, text in first language 710, text in second language 715, selected font 720, and matched font 725.

An embodiment of the present disclosure is configured to train a deep learning model for a classification task. Embodiments of the present disclosure include a training component configured to train the deep learning based classification model for predicting the font in the second language based on an image comprising text (e.g., an image depicting a template) in a first language. In some cases, as shown in FIG. 7, the deep learning model is trained jointly on a plurality of fonts from the language (e.g., a plurality of fonts for each of the plurality of languages 705) which ensures that the deep learning model learns the correlation and differences between the plurality of fonts across the languages 705. The training component is configured to train the deep learning based classification model based on the dataset generated by the data generation framework 700.

In some cases, the deep learning model is trained based on synthetic data generated by the data generation framework 700. For example, the synthetic data is generated by incorporating random text on a random background. In some examples, during selection of a random text, the machine learning model generates text in the first language 710 with a 0.5 (50%) probability and text in the second language 715 with a 0.5 (50 %) probability for each second language of the plurality of the second languages. As shown in FIG. 7, for example, the first language refers to English language and the second language refers to any of the other languages, such as Japanese, Korean, Chinese Simplified, or Chinese Traditional. However, embodiments are not limited thereto, and the first and second languages may refer to any other language not mentioned herein.

Accordingly, by generating part of the text in the first language (as shown in 710), embodiments of the present disclosure are able to ensure that the image encoder model is able to learn cross language similarity. Additionally, by generating part of the text in the second language (as shown in 715), an exemplary embodiment enables the image encoder model to learn a similarity between Roman glyph and a glyph in the second language.

In some cases, the image encoder model is trained with images comprising text depicting a first font in the first language. Additionally, the image encoder model is configured to select a font 720 in the second language that is visually similar to the first font. In some cases, the image encoder model is exclusively trained with images comprising text depicting a font 720 in the second language corresponding to the first font in the first language. In some cases, the data generation framework 700 comprises generation of image renditions of text in the first language 710 and image renditions of text in the second language 715 to train the image encoder model for visual similarity.

Accordingly, the data generation framework 700 generates matched font 725 comprising a first image in the first language that is paired with a second image in the second language. In some examples, the first image and the second image comprise text in first language and second language, respectively, while depicting font in the first image that is visually similar to the font in the second image. Therefore, embodiments are able to ensure the image encoder model understands the visual similarity.

In case the image encoder model is exclusively trained with images comprising text in the second language, the image encoder model skips a learning of the inter-language similarity since the distinguishing font in the second language (e.g., plurality of different second languages) is straightforward and less demanding.

According to an exemplary embodiment of the present disclosure, the data generation framework 700 further includes determination of a boundary of text. In some examples, stroke and shadow is applied over the text fill. For example, text with no boundary, stroke, and shadow are selected with a probability of 0.8, 0.1, and 0.1, respectively. In case of stroke boundary, the stroke width is determined relative to the font size. For a given font size, stroke width is uniformly sampled from [0.5, max (0.5, 0.5+(fontsize−50)/25)]. For shadow creation, the same text is rendered as fill, but of different color at few pixel offset from the location of original text. Pixel offset is defined by a tuple (x, y) where x is the offset in horizontal direction and y is the offset in vertical direction relative to the original text. x and y are sampled uniformly from the range [−5, 5].

Subsequently, the data generation framework 700 is used to determine the fill color and background of image. For example, in case of an image with a boundary (i.e., stroke/shadow), three RGB colors are selected to color the fill, boundary, and background. In some examples, the three RGB colors include sufficient pairwise contrast. In some examples, an RGB color is used for fill and a real image is used for the background. In some examples, an RGB color is used for the background and a real image is embedded inside the fill.

FIG. 8 shows an example of a method of training a machine learning model according to aspects of the present disclosure. FIG. 8 is a flow diagram depicting an algorithm as a step-by-step procedure 800 in an example implementation of operations performable for training a machine-learning model. In some embodiments, the procedure 800 describes an operation of the training component 1025 described for configuring the image encoder model 1015 as described with reference to FIG. 10. The procedure 800 provides one or more examples of generating training data, use of the training data to train a machine-learning model, and use of the trained machine-learning model to perform a task.

To begin in this example, a machine-learning system collects training data (block 802) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 804) to a type of task, for which the machine-learning model is to be trained. Task examples include classification, document processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 806). Initialization of the machine-learning model includes selecting a model architecture (block 808) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 810). The loss function is utilized to measure a difference between an output of the machine-learning model (i.e., predictions) and target values (e.g., as expressed by the training data) to be used to train the machine-learning model. Additionally, an optimization algorithm is selected (812) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 814) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 818) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 820), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 820), the procedure 800 continues training of the machine-learning model using the training data (block 818) in this example.

If the stopping criterion is met (“yes” from decision block 820), the trained machine-learning model is then utilized to generate an output based on subsequent data (block 822). The trained machine-learning model, for instance, is trained to perform a task as described above and therefore, once trained, is configured to perform that task based on subsequent data received as an input and processed by the machine-learning model. The machine learning model is an example of, or includes aspects of, the corresponding element described with reference to FIGS. 2, 9, and 10.

### Computing Device

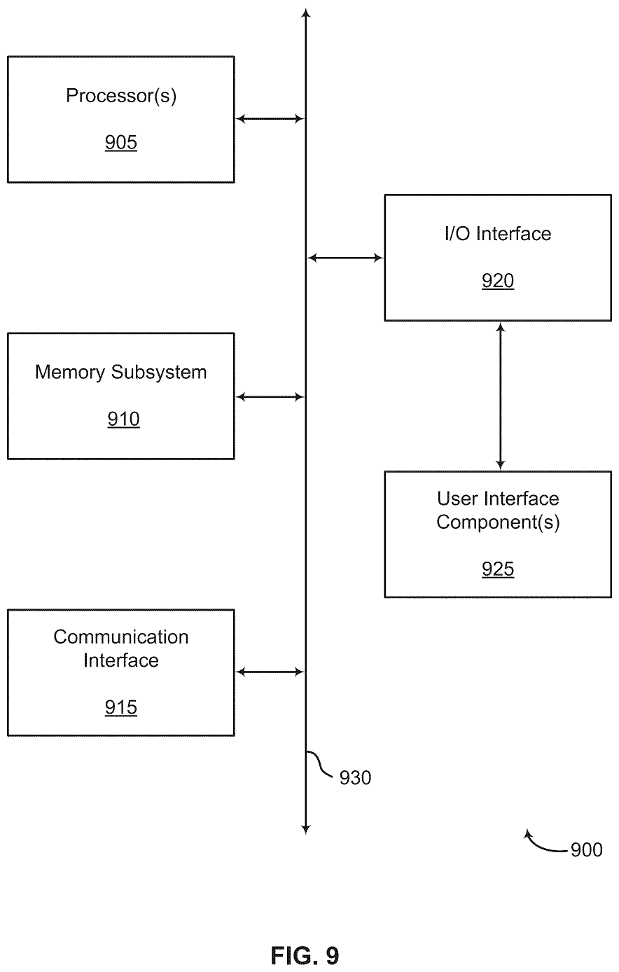

FIG. 9 shows an example of a computing device according to aspects of the present disclosure. The computing device 900 may be an example of the document processing apparatus 1000 described with reference to FIG. 10. In one aspect, computing device 900 includes processor(s) 905, memory subsystem 910, communication interface 915, I/O interface 920, user interface component(s) 925, and channel 930.

In some embodiments, computing device 900 is an example of, or includes aspects of, the image encoder model of FIGS. 10-11. In some embodiments, computing device 900 includes one or more processors 905 that can execute instructions stored in memory subsystem 910 to perform document translation.

According to some aspects, computing device 900 includes one or more processors 905. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 915 operates at a boundary between communicating entities (such as computing device 900, one or more user devices, a cloud, and one or more databases) and channel 930 and can record and process communications. In some cases, communication interface 915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 920 is controlled by an I/O controller to manage input and output signals for computing device 900. In some cases, I/O interface 920 manages peripherals not integrated into computing device 900. In some cases, I/O interface 920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 920 or via hardware components controlled by the I/O controller.

According to some aspects, user interface component(s) 925 enable a user to interact with computing device 900. In some cases, user interface component(s) 925 include an audio device, such as an external speaker system, an external display device such as a display screen, an input device (e.g., a remote-control device interfaced with a user interface directly or through the I/O controller), or a combination thereof. In some cases, user interface component(s) 925 include a GUI.

FIG. 10 shows an example of a document processing apparatus according to aspects of the present disclosure. Document processing apparatus 1000 is an example of, or includes aspects of, the corresponding element described with reference to FIGS. 2, 8, and 9. In one aspect, document processing apparatus 1000 includes processor unit 1005, memory unit 1010, I/O module 1020, and training component 1025. Training component 1025 updates parameters of the image encoder model 1015 stored in memory unit 1010. In some examples, the training component 1025 is located outside the document processing apparatus 1000.

According to some aspects, document processing apparatus 1000 obtains a first image depicting a first font in a first language. In some examples, document processing apparatus 1000 obtains a second image depicting the second font in the second language. In some examples, document processing apparatus 1000 obtains a set of first images depicting the first font in the first language, where the set of first images include a set of different font attributes, respectively. In some examples, document processing apparatus 1000 obtains a set of second images depicting the second font in the second language, where the set of second images include a set of different font attributes, respectively. In some examples, document processing apparatus 1000 obtains a document template including the first font in the first language. In some aspects, the first language has a different script than the second language.

According to some aspects, document processing apparatus 1000 obtains a second image depicting the second font in the second language. According to some aspects, document processing apparatus 1000 obtains a set of first images depicting the first font in the first language, where the set of first images include a set of different font attributes, respectively.

According to some aspects, document processing apparatus 1000 obtains a set of second images depicting the second font in the second language, where the set of second images include a set of different font attributes, respectively. According to some aspects, document processing apparatus 1000 obtains a document template including the first font in the first language, where the document is generated based on the document template.

According to some aspects, document processing apparatus 1000 comprises obtaining a first image depicting a first font in a first language. In some aspects, the processing device of the document processing apparatus is further configured to perform operations including obtaining a document template including the first font in the first language.

Processor unit 1005 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1005 is configured to operate a memory array using a memory controller. In other cases, a memory controller is integrated into processor unit 1005. In some cases, processor unit 1005 is configured to execute computer-readable instructions stored in memory unit 1010 to perform various functions. In some aspects, processor unit 1005 includes special purpose components for modem processing, baseband processing, digital signal processing, or transmission processing. According to some aspects, processor unit 1005 comprises one or more processors described with reference to FIG. 9.

Memory unit 1010 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1005 to perform various functions described herein.

In some cases, memory unit 1010 includes a basic input/output system (BIOS) that controls basic hardware or software operations, such as an interaction with peripheral components or devices. In some cases, memory unit 1010 includes a memory controller that operates memory cells of memory unit 1010. For example, the memory controller may include a row decoder, column decoder, or both. In some cases, memory cells within memory unit 1010 store information in the form of a logical state. According to some aspects, memory unit 1010 is an example of the memory subsystem 910 described with reference to FIG. 9.

According to some aspects, document processing apparatus 1000 uses one or more processors of processor unit 1005 to execute instructions stored in memory unit 1010 to perform functions described herein. For example, the document processing apparatus 1000 may obtain a first image depicting a first font in a first language; encode the first image to obtain a first image embedding representing the first font; compute a similarity score between the first font and a second font in a second language based on the first image embedding; and select the second font as a similar font to the first font in the second language based on the similarity score.

In one aspect, memory unit 1010 includes image encoder model 1015 trained to obtain a first image depicting a first font in a first language; encode the first image to obtain a first image embedding representing the first font; compute a similarity score between the first font and a second font in a second language based on the first image embedding; and select the second font as a similar font to the first font in the second language based on the similarity score.

For example, after training, the image encoder model 1015 may perform inferencing operations as described with reference to FIGS. 1-3 to obtain a first image depicting a first font in a first language; encode the first image to obtain a first image embedding representing the first font; compute a similarity score between the first font and a second font in a second language based on the first image embedding; and select the second font as a similar font to the first font in the second language based on the similarity score.

In some embodiments, the image encoder model 1015 is an Artificial neural network (ANN) comprising a plurality of networks. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image encoder model 1015 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1025 may train the image encoder model 1015. In some aspects, training component 1025 trains image encoder model 1100 to generate embeddings representing fonts in a set of different languages using a training set that includes images depicting fonts in the set of different languages.

For example, parameters of the image encoder model 1015 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 8). The goal of the training process may be to find optimal values for the parameters that allow the language generation model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image encoder model 1015 can be used to make predictions on new, unseen data (i.e., during inference). Image encoder model 1015 is an example of, or includes aspects of, the corresponding element described with reference to FIG. 11.

I/O module 1020 receives inputs from and transmits outputs of the document processing apparatus 1000 to other devices or users. For example, I/O module 1020 receives inputs for the image encoder model 1015 and transmits outputs of the image encoder model 1015. According to some aspects, I/O module 1020 is an example of the I/O interface 920 described with reference to FIG. 9.

FIG. 11 shows an example of an image encoder model 1100 according to aspects of the present disclosure.

According to some aspects, image encoder model 1100 encodes the first image to obtain a first image embedding representing the first font. In some examples, image encoder model 1100 computes a similarity score between the first font and a second font in a second language based on the first image embedding. In some examples, image encoder model 1100 selects the second font as a similar font to the first font in the second language based on the similarity score. In some examples, image encoder model 1100 encodes the second image to obtain a second image embedding, where the similarity score is based on a similarity between the first image and the second image.

In some examples, image encoder model 1100 encodes each of the set of first images to obtain a set of first image embeddings, where the similarity score is based on the set of first image embeddings. In some examples, image encoder model 1100 encodes each of the set of second images to obtain a set of second image embeddings, where the similarity score is based on the set of second image embeddings. In some examples, image encoder model 1100 computes the similarity score including generating a matrix of similarity values based on the set of first image embeddings and the set of second image embeddings, where the similarity score is based on the matrix of similarity values.

In some examples, image encoder model 1100 generates a document with the second font in the second language based on the document template and the selection of the second font as the similar font to the first font. In some examples, image encoder model 1100 generates a mapping between a set of fonts in the first language and a set of fonts in the second language based on selection of the second font as the similar font. In some aspects, the image encoder model 1100 is trained to generate embeddings representing fonts in a set of different languages using a training set that includes images depicting fonts in the set of different languages.

According to some aspects, image encoder model 1100 encodes a first image to obtain a first image embedding representing a first font. In some examples, image encoder model 1100 computes a similarity score between the first font and a second font in a second language based on the first image embedding. In some examples, image encoder model 1100 generates a document with the second font in the second language based on the similarity score. According to some aspects, image encoder model 1100 encodes the second image to obtain a second image embedding, where the similarity score is based on a similarity between the first image and the second image. In one aspect, image encoder model 1100 includes residual network 1105 and convolutional neural network 1110.

Residual network 1105 (ResNet) is a deep neural network architecture designed to prevent a vanishing gradient and facilitate the training of very deep neural networks. ResNet is based on residual learning, where shortcut connections bypass one or more layers. The connections provide for the network to learn residual functions relative to the input, rather than attempting to learn the direct mapping. A ResNet comprises residual blocks, each comprising convolutional layers followed by batch normalization and ReLU activation. The shortcut connection adds the input of a block to the corresponding output, enabling efficient gradient flow during backpropagation.

In some cases, residual network (such as residual network 1105) performs skip connection where input to a layer is added back to the corresponding output. As such, a layer of the network learns F(X)=H(X)−X instead of H(X) for input X. Here, F(X) refers to residual which is easier to learn than H(X). In some cases, residual network 1105 is used to extract a feature for font matching. In some examples, an Adam optimizer with an initial learning rate of 10⁻³ is used to train the residual network model. In some cases, the design of the residual network mitigates degradation problems in deep networks and provides for the network to achieve high accuracy by enabling the effective training of networks with a plurality of layers (e.g., hundreds or thousands of layers).

Convolution neural network (CNN) 1110 is a specialized artificial neural network architecture designed to process data with a grid-like topology, such as images. It consists of multiple layers that automatically and adaptively learn spatial hierarchies of features from input data. A typical CNN includes convolutional layers, pooling layers, and fully connected layers. Convolutional layers apply filters to the input data, and perform convolution operations to extract features like edges, textures, or more complex patterns. Pooling layers reduce the spatial dimensions of the feature maps while enhancing computational efficiency and minimizing overfitting. Fully connected layers integrate extracted features into a final decision or classification output. CNNs leverage local connectivity and weight sharing, significantly reducing the number of parameters compared to fully connected networks. The architecture is particularly effective in tasks such as image recognition, object detection, and document processing, where spatial patterns or hierarchical features are crucial for accurate analysis.

In some cases, residual network 1105 and CNN 1110 are an example of a neural network component. In some cases, each of residual network 1105 and CNN 1110 can be arranged as layers or blocks within a same neural network (i.e., single network architecture). For example, the neural network includes CNN 1110 for feature extraction. Additionally, for example, the neural network includes residual network 1105 for gradient flow in the deeper layers of the network.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a first image depicting a first font in a first language;
encoding, using an image encoder model, the first image to obtain a first image embedding representing the first font;
computing a similarity score between the first font and a second font in a second language based on the first image embedding;
selecting the second font as a similar font to the first font in the second language based on the similarity score; and
generating a document with the second font in the second language based on the selection of the second font as the similar font to the first font.

2. The method of claim 1, further comprising:
obtaining a second image depicting the second font in the second language; and
encoding the second image to obtain a second image embedding, wherein the similarity score is based on a similarity between the first image and the second image.

3. The method of claim 1, further comprising:
obtaining a plurality of first images depicting the first font in the first language, wherein the plurality of first images comprise a plurality of different font attributes, respectively; and
encoding each of the plurality of first images to obtain a plurality of first image embeddings, wherein the similarity score is based on the plurality of first image embeddings.

4. The method of claim 3, further comprising:
obtaining a plurality of second images depicting the second font in the second language, wherein the plurality of second images comprise a plurality of different font attributes, respectively; and
encoding each of the plurality of second images to obtain a plurality of second image embeddings, wherein the similarity score is based on the plurality of second image embeddings.

5. The method of claim 4, wherein computing the similarity score comprises:
generating a matrix of similarity values based on the plurality of first image embeddings and the plurality of second image embeddings, wherein the similarity score is based on the matrix of similarity values.

6. The method of claim 1, further comprising:
obtaining a document template comprising the first font in the first language, wherein the document is based on the document template.

7. The method of claim 1, further comprising:
generating a mapping between a plurality of fonts in the first language and a plurality of fonts in the second language based on selection of the second font as the similar font.

8. The method of claim 1, wherein:
the first language has a different script than the second language.

9. The method of claim 1, wherein:
the image encoder model is trained to generate embeddings representing fonts in a plurality of different languages using a training set that includes images depicting fonts in the plurality of different languages.

10. A non-transitory computer readable medium storing code for document processing, the code comprising instructions that, when executed by at least one processor, cause the at least one processor to perform operations comprising:
encoding, using an image encoder model, a first image to obtain a first image embedding representing a first font;
computing a similarity score between the first font and a second font in a second language based on the first image embedding; and
generating a document with the second font in the second language based on the similarity score.

11. The non-transitory computer readable medium of claim 10, the code further comprising instructions that, when executed by the at least one processor, cause the at least one processor to perform operations comprising:
obtaining a second image depicting the second font in the second language; and
encoding the second image to obtain a second image embedding, wherein the similarity score is based on a similarity between the first image and the second image.

12. The non-transitory computer readable medium of claim 10, the code further comprising instructions that, when executed by the at least one processor, cause the at least one processor to perform operations comprising:
obtaining a plurality of first images depicting the first font in the first language, wherein the plurality of first images comprise a plurality of different font attributes, respectively; and
encoding each of the plurality of first images to obtain a plurality of first image embeddings, wherein the similarity score is based on the plurality of first image embeddings.

13. The non-transitory computer readable medium of claim 12, the code further comprising instructions that, when executed by the at least one processor, cause the at least one processor to perform operations comprising:
obtaining a plurality of second images depicting the second font in the second language, wherein the plurality of second images comprise a plurality of different font attributes, respectively; and
encoding each of the plurality of second images to obtain a plurality of second image embeddings, wherein the similarity score is based on the plurality of second image embeddings.

14. The non-transitory computer readable medium of claim 10, the code further comprising instructions that, when executed by the at least one processor, cause the at least one processor to perform operations comprising:
obtaining a document template comprising the first font in the first language, wherein the document is generated based on the document template.

15. The non-transitory computer readable medium of claim 10, the code further comprising instructions that, when executed by the at least one processor, cause the at least one processor to perform operations comprising:
the image encoder model is trained to generate embeddings representing fonts in a plurality of different languages using a training set that includes images depicting fonts in the plurality of different languages.

16. A system comprising:
a memory component; and
a processing device coupled to the memory component, the processing device configured to perform operations comprising:
obtaining a first image depicting a first font in a first language;
encoding, using an image encoder model, the first image to obtain a first image embedding representing the first font;
computing a similarity score between the first font and a second font in a second language based on the first image embedding;
selecting the second font as a similar font to the first font in the second language based on the similarity score; and
generating a document with the second font in the second language based on the selection of the second font as the similar font to the first font.

17. The system of claim 16, wherein:
the image encoder model comprises a convolutional neural network.

18. The system of claim 16, wherein:
the image encoder model comprises a ResNet architecture.

19. The system of claim 16, wherein:
the image encoder model is trained to generate embeddings representing fonts in a plurality of different languages using a training set that includes images depicting fonts in the plurality of different languages.

20. The system of claim 16, wherein the processing device is further configured to perform operations comprising:
obtaining a document template comprising the first font in the first language, wherein the document is based on the document template.
